(19) United States
(12) Patent Application Publication
(10) Pub. No.: US 2012/0131487 A1
(43) Pub. Date: May 24, 2012

(54) Analysis, visualization and display of curriculum vitae data

(76) Inventor: Kathleen Ann Leonard, New York, NY (US)

(21) Appl. No.: 12/927,627

(22) Filed: Nov. 19, 2010

(51) Int. Cl. G06F 3/048

(52) U.S. Cl. 715/771

(57) ABSTRACT

The claimed system and method is directed to the extraction, scoring, visualization and display of employment-related data, particularly data typically found in a resume or curriculum vitae seeking professional employment. The curriculum vitae dashboard and scorecard streamlines the graphical presentation of professional experience data. The holistic approach creates an overview of qualifications and experiences, allowing one section to influence another. A visual high-level summary of professional, academic and personal accomplishments allows a unique presentation for each candidate while providing a scalable solution for reviewing a large volume of applicants. The system and method allow a candidate to leverage self-defined quantifiable metrics including skills, experience and chronology in a variety of visual displays as determined by the user.

### BACKGROUND OF THE INVENTION

The claimed systems and methods relate to data visualization. More specifically, the claimed systems and methods relate to the extraction, scoring, visualization and display of professional experience and employment-related data, particularly data typically found in a resume or curriculum vitae used in application for professional employment.

Traditional or conventional resume formats, though used extensively, have notable limitations. One limitation is the tedious and time consuming process of writing a resume. A second limitation of the traditional format is the presentation. The main component of the traditional format includes pages of text and is not conducive to rapid review, assimilation or digestion. The process of reviewing hundreds of resumes, if done at all, has been relegated to either a quick check, or, for larger entities, software based searches for keywords, rejecting those failing to satisfy a set of business rules imposed to reduce the number of eligible candidates. A third limitation also occurs when a large volume of resumes are examined. With a large volume of resumes to review, comparing one to another quickly becomes a task just as onerous as the initial review. Employers are overwhelmed with the volume of resumes and the information they typically contain. In addition, candidates are increasingly unable to communicate or highlight their respective skills and experience effectively. The traditional resume is simply too long, overly verbose and also requires ongoing edits in order for a candidate to customize the document for distinct employment opportunities.

Accordingly, there exists a need for a more effective way of communicating professional experience and employment data in a fast, efficient and intuitive manner. One object of the claimed system and method includes generating a graphical dashboard interface visually representing professional experience and employment data. Another object of the claimed system and method includes generating a graphical scorecard interface visually representing professional experience and employment data. Another object is to assist users in defining the appropriate level of detail that needs to be presented on paper versus experiences that should be discussed through a more formal interview process.

Another object of the claimed system and method is alleviating the tedious process of resume writing into a several efficient components through use of select visual components. Yet another object is to translate textual data into visually intuitive graphics using color and layout to convey a summary of notable credentials. Yet another object of the claimed system and method facilitates the review process enabling readers to make fast and easy comparisons between candidates. By reducing textual content and bullet points, the visual approach increases comprehension and efficiency of candidate review. In addition to the creation of a visual resume, the claimed system and method is envisioned for the facilitation of processes internal to an organization, such as promotion, compensation review and career planning.

### BRIEF SUMMARY OF THE INVENTION

The system and method for visualizing curriculum vitae data includes receiving a foundation data set including matrix data and experiential data and structuring a foundation data set into at least one schema framework including a plurality of dashboard elements. The system and method includes mapping the dashboard elements in a given schema framework to form relationship metadata within the foundation data set and generating an adaptive graphic visualization representing the foundation data set including a customizable interface layout.

In one embodiment, the matrix data includes a chronology field and an industry field. Experiential data may include a functional subset and a skills subset. The functional subset may include an umbrella field and the skill subset includes a set of skill fields associated with a corresponding set of skill weights. Other attributes and factors will be readily apparent to those of skill in the art, for example, user-defined attributes may also be included in the matrix data and experiential data sets. In one embodiment, the method for visualizing curriculum vitae data may include quantitative data.

The system and method for visualizing curriculum vitae data may also include associating matrix data with a graphical matrix dashboard element and associating experiential data with a graphical experiential dashboard element. The system and method further includes representing relationship metadata within the foundation data set through a common attribute shared between the graphical matrix dashboard element and the graphical experiential dashboard element. In one embodiment, associating matrix data with the graphical matrix dashboard elements may include a user-defined preference, the user-defined preference being a selection of shape and color, format and type of chart or table.

According to one embodiment, the step of representing relationship metadata within the foundation data set through a common attribute may also include influencing a visual characteristic of the graphical experiential dashboard element relative to data represented by the graphical matrix dashboard element. In addition, the adaptive graphic visualization may include an interactive component wherein the interactive component may include an operator configured to return a refined data set from the foundation data set upon request. In one embodiment, the adaptive graphic visualization includes a plurality of interactive components, each one of the interactive components being associated with a given dashboard element. The adaptive graphic visualization may also include a relative interactive component configured to return the refined data set according to relationship metadata formed in mapping dashboard elements or by a user-defined relationship.

Other advantages of this visualizing method will be more fully apparent from the following disclosure and appended claims.

### BRIEF DESCRIPTION OF THE DRAWINGS

The above-mentioned and other features and objects of the claimed systems and methods and the manner of obtaining them will become apparent and will be best understood by reference to the following description of an embodiment taken in conjunction with the accompanying drawings, wherein:

FIG. 1 is a block diagram illustrating one embodiment of a system and method for visualizing curriculum vitae data;

FIG. 2 is a flow diagram illustrating one embodiment of a system and method for visualizing curriculum vitae data;

FIG. 3 is a flow diagram illustrating one embodiment of a system and method for visualizing curriculum vitae data;

FIG. 4a illustrates a sample graphical interface as generated by the system and method for visualizing curriculum vitae data;

FIG. 4b illustrates a sample graphical interface as generated by the system and method for visualizing curriculum vitae data;

FIG. 5a illustrates another sample graphical interface as generated by the system and method for visualizing curriculum vitae data;

FIG. 5b illustrates another sample graphical interface as generated by the system and method for visualizing curriculum vitae data;

FIG. 6a illustrates another sample graphical interface as generated by the system and method for visualizing curriculum vitae data; and

FIG. 6b illustrates another sample graphical interface as generated by the system and method for visualizing curriculum vitae data.

### DETAILED DESCRIPTION

In the following description, reference is made to the accompanying drawings that form a part hereof, and in which is shown by way of illustration specific embodiments in which the claimed system and method may be practiced. It is to be understood that other embodiments may be utilized and structural changes may be made without departing from the scope of the claimed system and method. To better understand the claimed system and method, some of the following embodiments are expressed in terms of sample visualizations.

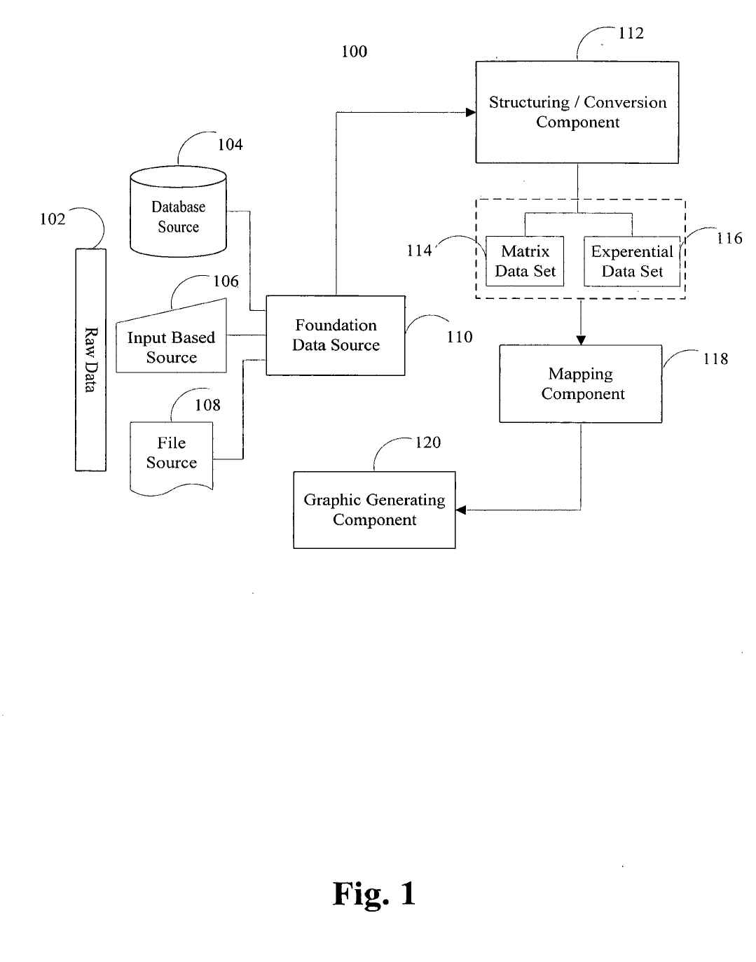

FIG. 1 is a block diagram illustrating one embodiment of a system for visualizing curriculum vitae data. The system 100 includes raw data 102, a database source 104, an input based source 106, a file source 108, a foundation data source 110, a structuring/conversion component 112, a matrix data set 114, an experiential data set 116, a mapping component 118 and a graphic generating component 120.

Raw data 102 includes unprocessed information representing the qualitative or quantitative attributes of a variable or set of variables. In some cases, raw data 102 may be analog or digital data, unencoded or unformatted data, and even formatted data. The database source 104 may include a collection of data for one or more multiple uses. The database source 104 may include a database architecture or a plurality of database architectures used in combination. The general structure of the database architecture is tabular, comprising of rows and columns of information. Other architectures, such as row oriented and column oriented may also define the database source. Document-Oriented, extensible modeling language (“XML”) and knowledgebases may also use a combination of these architectures to implement the database source 104. These object databases may store the relationships between complex data types as part of their storage model in a way that does not require runtime calculation of related data using relational algebra execution algorithms.

The input source 106 is any peripheral device used to provide data and control signals to the system 100. Some input sources may include a keyboard, a mouse, a mobile device, a multi-touch screen, an image capture device, a sensor and the like. A file source 108 is a collection of information structured and encapsulated in a specified format. In one embodiment, the file source 108 may include a question and answer form completed online or offline. The question and answer form may include basic questions serving as an outline to streamline the use of a curriculum vitae dashboard or curriculum vitae scorecard component.

As illustrated, the foundation data source 110 may be associated with the database source 104, the input based source 106 and file source 108. The foundation data source 104 may include a networked computer or server (not shown) having a processing device and a set of software components. The computer or server may include a processor, transient and persistent storage devices, input/output subsystem and bus to provide a communications path between components comprising a general purpose computer. Other network-based devices are considered to fall within the scope of the claimed system and method including, but not limited to, hand held devices, set top terminals, mobile handsets, PDAs, etc. In one embodiment, the server may include one or more server devices operative to perform server operations, including interfacing with foundation data source 110 and the software components. The server may be further operative to receive and transmit information over a network to a plurality of users and parties through a variety of network devices that will be apparent to those of skill in the art.

One of ordinary skill in the art will appreciate the availability of different versions and implementations in collecting the foundation data set for use with the dashboard interface or scorecard interface. These versions may depend on a particular candidate, a career path and career objectives. In addition, a particular version may include the creation of a foundation data set and interface generation for users interested in a results oriented emphasis. Another version may include the creation of a foundation data set and interface generation for users interested in focusing on a skills inventory. Notably, none of the embodiments and associated components is mutually exclusive.

The structuring/conversion component 112 may comprise one or more processing elements operative to perform processing operations in response to executable instructions, collectively as a single element or as various processing modules, which may be physically or logically disparate elements. It may also be embodied as software associated with any suitable type of processing device operative to perform processing operations as described in further detail below. In one embodiment, the structuring/conversion component 112 receives data from the foundation data source 110 and structures/converts the data into a predefined format. The predefined format may be any suitable format capable of being processed by a plurality of devices.

According to FIG. 1, the structuring/conversion component 112 performs operations on the foundation data source 110 to create a matrix data set 114 and an experiential data set 116. The matrix data set 114 may include information stored in a variety of attributes. Some of those attributes may include, but are not limited to, a company attribute, a title attribute, a time attribute, an industry attribute and a credentials attribute. In addition, the matrix data set 114 keeps standard attributes organized and succinct without unnecessary detail. In one embodiment, the matrix data set may include five columns: Time, Company, Title, Industry, Credentials. In one embodiment, the chronology attribute may be'title based for a candidate holding multiple positions at one organization over the course of the candidate's career. Alternatively, the chronology attribute may blend with the experiential data set 116.

Indeed, the matrix data set 114 may also feed into the experiential data set 116. Similarly, the experiential data set 116 may also store information in a variety of attributes. Some of those attributes may include, but are not limited to, a chronology attribute and a distribution of professional experiences attribute.

In one embodiment, the matrix data set 114 and experiential data set 116 are combined to create dashboard elements as part of a graphical user interface. This combination may be accomplished through the mapping component 118 using a variety of techniques apparent to those of skill in the art. As illustrated in FIG. 1, the mapping component 118 may transmit information from the matrix data set 114 and experiential data set 116 to a graphic generating component 120. The mapping component 118 may comprise one or more processing elements operative to perform processing operations in response to executable instructions, collectively as a single element or as various processing modules, which may be physically or logically disparate elements.

The graphic generating component 120 may also comprise one or more processing elements operative to perform processing operations in response to executable instructions, collectively as a single element or as various processing modules, which may be physically or logically disparate elements. In one embodiment, the graphic generating component 120 may comprise a display device capable of rendering a dashboard element, interface and other generated graphics. In general, the concept of a dashboard element renders an “objective subjective” view, visually representing a candidate's experiences. The dashboard element may also leverage self-defined quantifiable metrics including skills, experience and chronology in a variety of visual displays according to user-defined preferences. Additionally, a dashboard/scorecard approach permits a holistic view of personal achievements, consolidating skills and accomplishments for a more abstract perspective. In one embodiment, the creation of dashboard/scorecard elements through the graphic generating component 120 may include a user interface allowing a user or group of users to interact with information aggregated in the foundation data source 110.

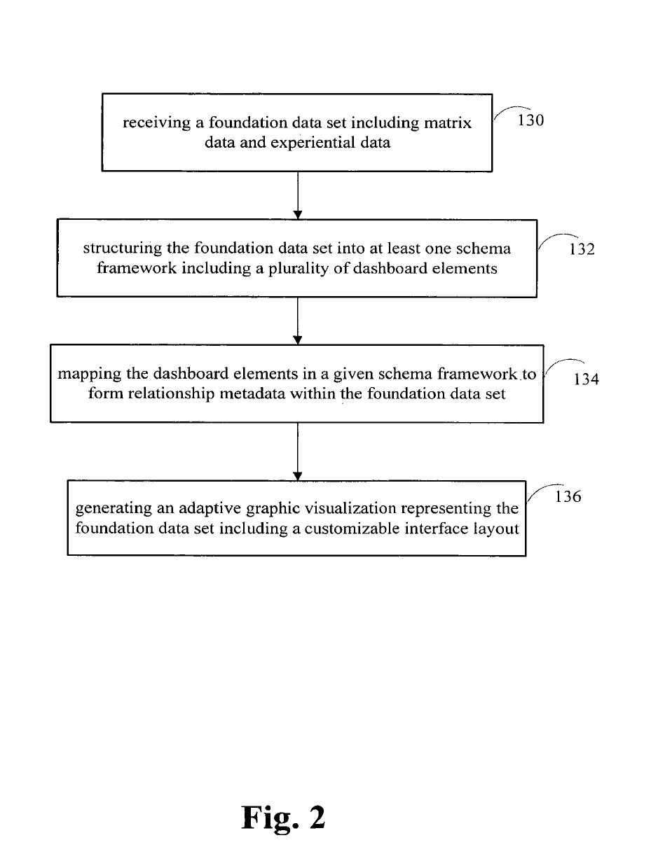

FIG. 2 is a flow diagram illustrating one embodiment of a system and method for visualizing curriculum vitae data. According to FIG. 2, the first step, step 130, is receiving a foundation data set including matrix data and experiential data. Relative back to FIG. 1, the step of receiving may include data transmissions from the database source 104, input source 106 or the file source 108. The next step, step 132 is structuring the foundation data set into at least one schema framework including a plurality of dashboard elements. A schema framework is a structure defined by a data modeling language typically supported by a database management system. In a relational system, the schema may define the structure of tables, fields, relationships, views, indexes, packages, procedures, functions, queues, triggers, data types, sequences, directories and other elements.

In one embodiment, the schema framework may include a genetic schema. The genetic schema is a schema framework evolving from a genetic algorithm applied to a populated data set with similar attributes represented in binary strings of 1s and 0s. The genetic algorithm includes a genetic representation of an ideal candidate and a qualification function for evaluating candidates in the foundation data set. The iterative approach of the genetic schema continuously evaluates each candidate and selects a specific set to form a new population of candidates. The genetic schema may continue the iterative approach indefinitely or terminate upon the new population of candidates reaching a predetermined size.

Next, the illustrated method of FIG. 2 performs step 134, mapping the dashboard elements in a given schema framework to form relationship metadata within the foundation data set. Mapping controls the relationship of attributes, fields, metadata and information associated with a given candidate as well as the relationship attributes, fields, metadata and information for a set of candidates. The nature of these relationships may be system-specific or user-defined. Some relationships may be defined as one-to-one, one-to-many, many-to-one or many-to-many.

The next step, step 136 is generating an adaptive graphic visualization representing the foundation data set including a customizable interface layout. In one embodiment, the adaptive graphic visualization may include image, audio and video data. The customizable interface layout allows the candidate to control the display of specific dashboard/scorecard elements. The graphic visualization is adaptive in the sense that it may receive and provide dynamic information, updated in real time. In one embodiment, the user may choose to include or request a given image for one application to a specific position while deciding to withhold the image for another application.

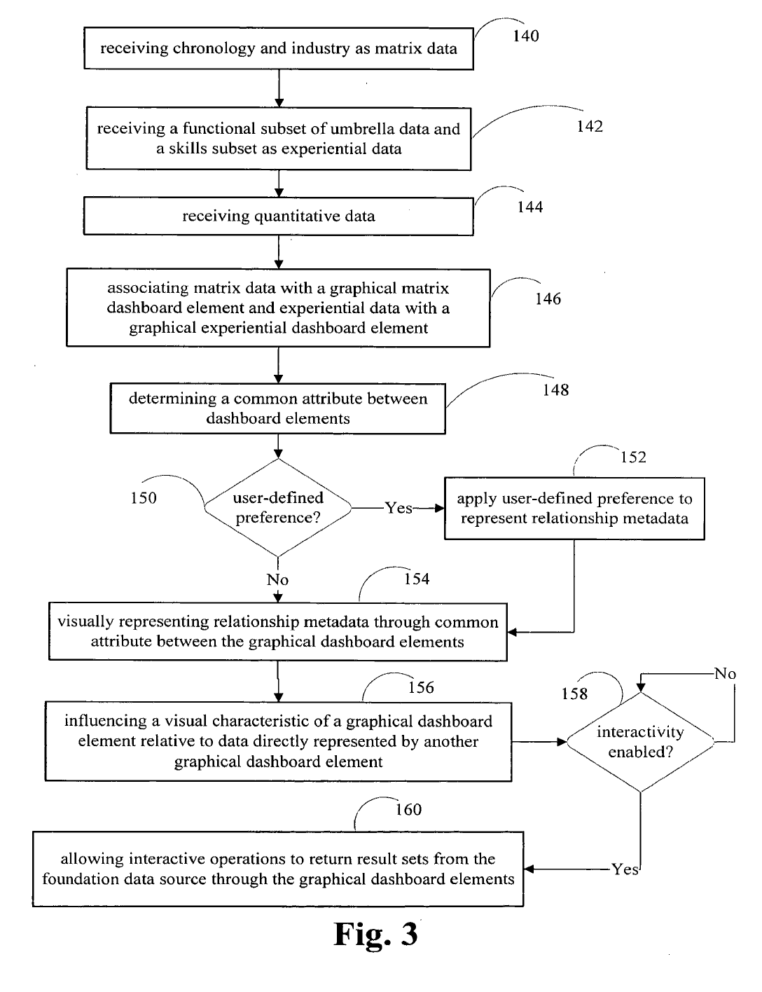

FIG. 3 is a flow diagram illustrating one embodiment of a system and method for visualizing curriculum vitae data. As illustrated in FIG. 3, step 140 includes receiving a chronology field and an industry field as matrix data. As mentioned above, the chronology field may blend with experiential data with an emphasis on the skills acquired by a candidate holding different positions around a particular skill set at one organization.

According to FIG. 3, step 142 is receiving a functional subset of umbrella data and a skills subset of skill fields and corresponding skill weights as experiential data. Umbrella data may include information about a candidate's association with a department within an organization, knowledge of a particular subject and professional training. Umbrella data allows a candidate to highlight areas of expertise, field of work, scope and focus. A candidate with varied experiences could have a plurality of umbrella data sets. Other candidates who have concentrated their career on one thing can have a more defined set. The skills subset includes descriptions of the tools used to perform job-related tasks. The tools may be stored in the functional subset as skill fields. The skill fields includes a set of foundation skills derived from a list of day to day experiences implying how a candidate spends time during employment. After the creation of this list, the candidate may rank each skill individually on a scale of 1 to 10, although other ranking techniques may be used.

The embodiment utilizing the 10 point scale technique assists the candidate and a reader of the candidate's dashboard/scorecard in understanding the depth of a candidate's experience. For example, a candidate's spreadsheet experience may rank the skill of Formula Creation at 8, Graphs at 10 and Macros at 7. The skills subset provides a showcase for a candidate's key achievements in terms of quantifiable results. In one embodiment, the skill fields are weighted or ranked according to weighting and ranking techniques readily apparent to those of skill in the art. In addition, a 10 point scorecard may represent an assessment of candidate's overall skills inventory and experience. In addition, a point-based assessment may consider a candidate's umbrellas, chronology, distribution, academic achievements and professional performance results.

The next step, step 144, is receiving quantitative data. Quantitative data is information capable of numerical expression and statistical analysis. Examples of quantitative data include, but are not limited to assets under management, legal verdicts, revenue generation, client development, years of experience, sales and the like. Next, the method illustrated performs step 146, associating matrix data with a graphical matrix dashboard element and experiential data with a graphical experiential dashboard element. The graphical dashboard elements may include timelines, color coded icons, Venn diagrams, boxplots, node-maps, bar charts, line graphs and the like. Step 148 is determining a common attribute between dashboard elements. In one embodiment, the common attribute among dashboard elements may be shading or color. In other embodiments, the common attribute may be font type, shape, label, location or position.

At step 150, a check is performed to determine if a user-defined preference exists. If a user-defined preference exists, the method performs step 152, applying the user-defined preference to represent relationship metadata. If a user-defined preference does not exist, the method performs step 154, visually representing relationship metadata through a default common attribute between the graphical dashboard elements. The next step, step 156 is influencing a visual characteristic of a graphical dashboard element relative to data directly represented by another graphical dashboard element.

At step 158, a check is performed to determine if interactivity is enabled. If interactivity is enabled, the method performs step 160, allowing interactive operations to return refined result sets from the foundation data source through the graphical dashboard elements. If interactivity is not enabled, the method continues normal operation and returns to step 158, periodically checking if interactivity is enabled.

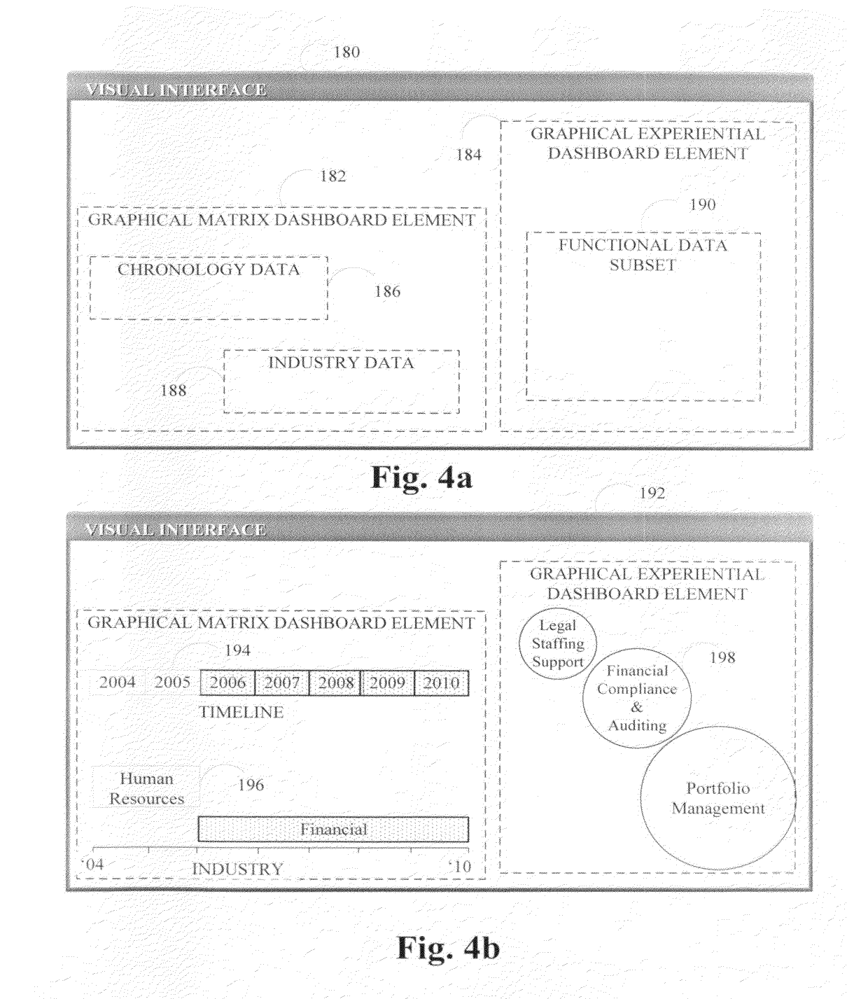

FIG. 4a illustrates a sample graphical interface as generated by the system and method for visualizing curriculum vitae data. This may be an ordinal component for arranging a hierarchy of data. The sample graphical interface 180 includes a graphical matrix dashboard element 182 and a graphical experiential dashboard element 184. The graphical matrix dashboard element 182 includes chronology data 186 and industry data 188. The graphical experiential dashboard element 184 includes a functional data subset 190.

FIG. 4b illustrates a sample graphical interface as generated by the system and method for visualizing curriculum vitae data. Similar to the interface of FIG. 4a, the sample graphical interface 192 includes a graphical matrix dashboard element and a graphical experiential dashboard element. As illustrated, the graphical matrix dashboard element represents the chronology data as timeline graphic 194 and the industry data as an industry bar graph 196 over time. The timeline illustrates units of time in years, but other units including day, week, month, year and decades may also be used. In addition, the graphical experiential dashboard element includes a functional data subset represented as a set of circles 198. As illustrated, the size of each circle visually indicates the candidate's relative experience with respect to the others.

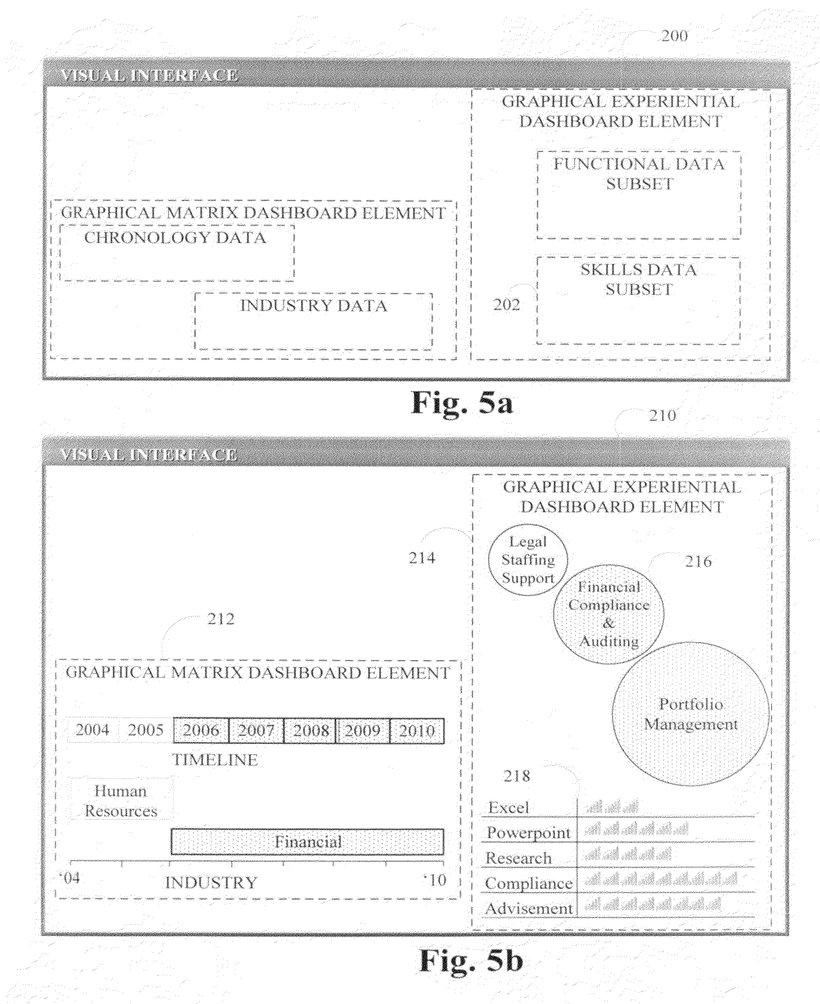

FIG. 5a illustrates a sample graphical interface as generated by the system and method for visualizing curriculum vitae data. As illustrated, the sample graphical interface 200 includes the same dashboard elements and data sets of FIG. 4a. In addition, the graphical experiential dashboard element further includes skills data subset 202.

FIG. 5b illustrates a sample graphical interface as generated by the system and method for visualizing curriculum vitae data. Similar to the interface of FIG. 4b, the sample graphical interface 210 includes a graphical matrix dashboard element 212 and a graphical experiential dashboard element 214. The graphical matrix dashboard element 212 represents the chronology data in as timeline graphic and the industry data as an industry bar graph over time.

In one embodiment, chronology data and industry data may include common visual attributes. For example, the graphical matrix dashboard element 212 incorporates shading to indicate a relationship between the chronology data and industry data. As illustrated in FIG. 5b, the skills data subset 218 may be represented as a set of ratings associated with a particular skill. For example, the Excel skill has 3 spark-lines while the Compliance skill has 9 spark-lines.

Also illustrated in FIG. 5b is shading. The shading of the objects 216 in the functional skills subset relate to the shading of the objects in the graphical matrix dashboard element 212. In other embodiments, these relationships may also be represented by color, line weight, fill, font, label and the like.

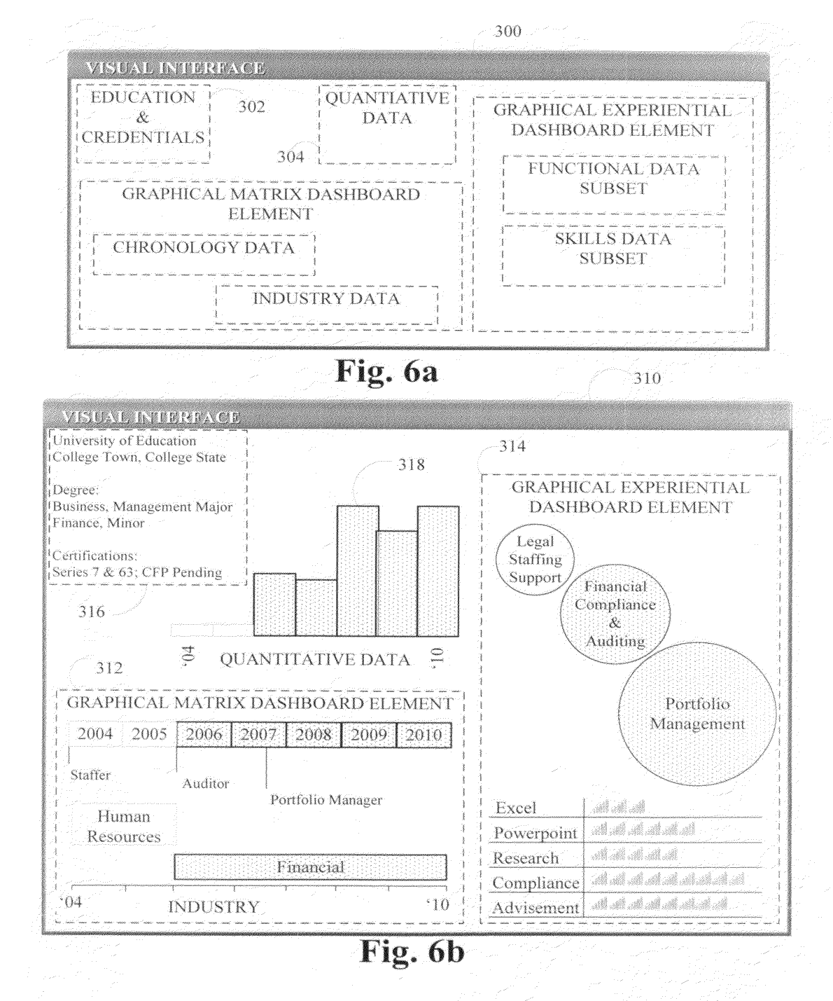

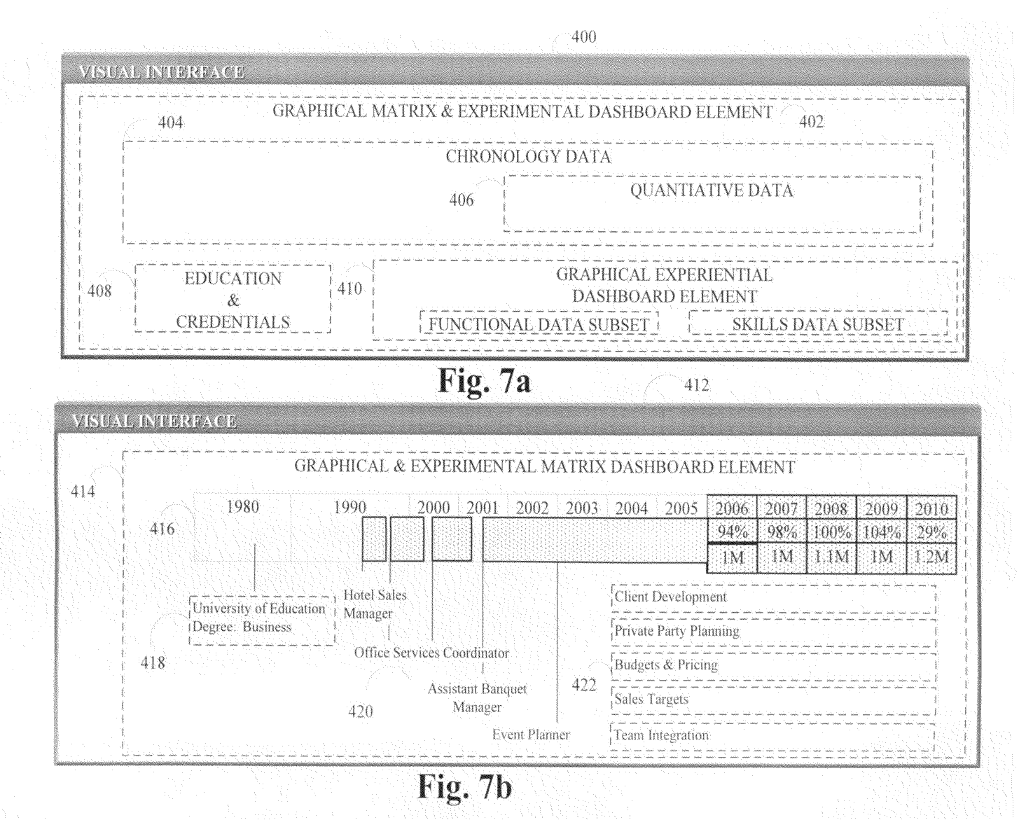

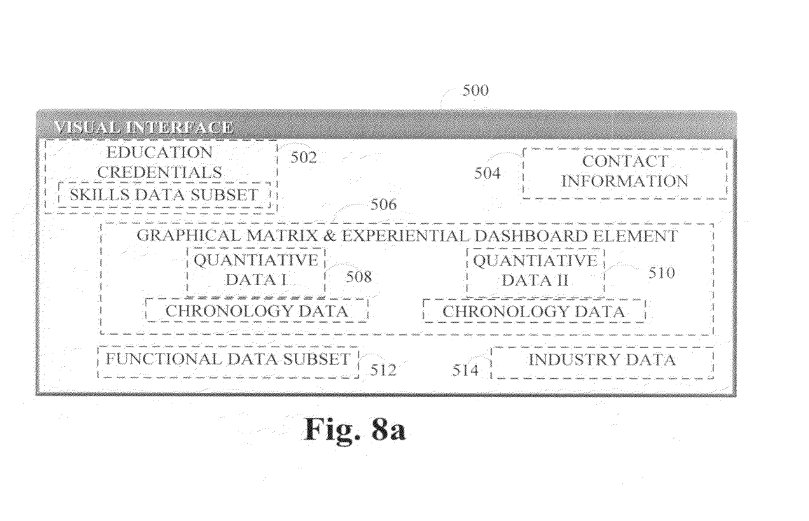

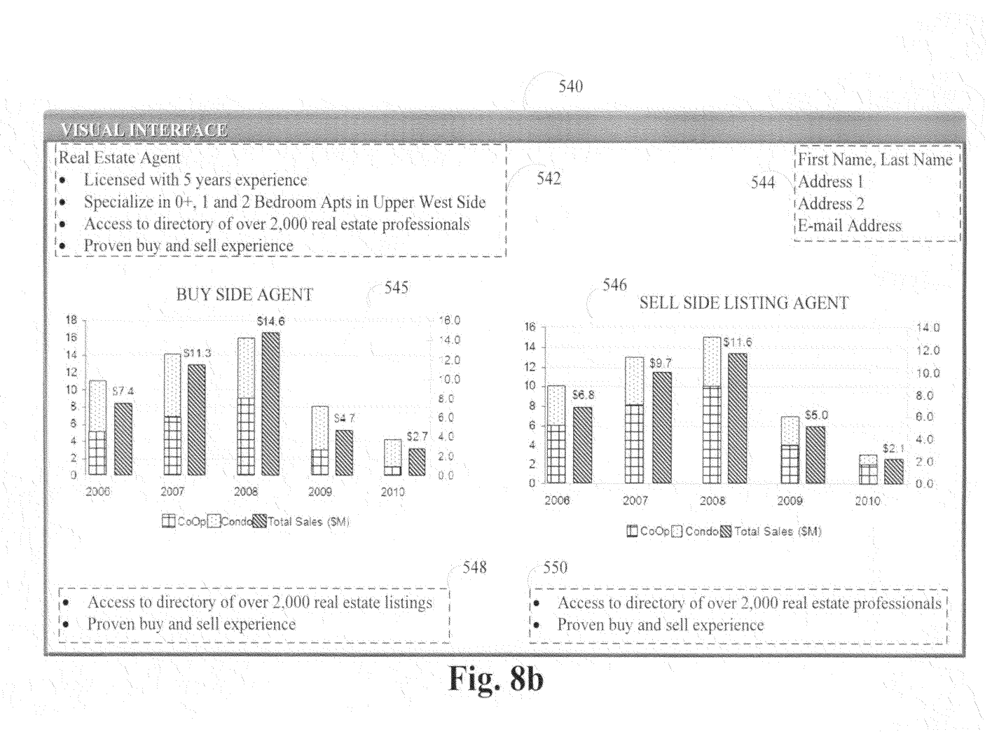

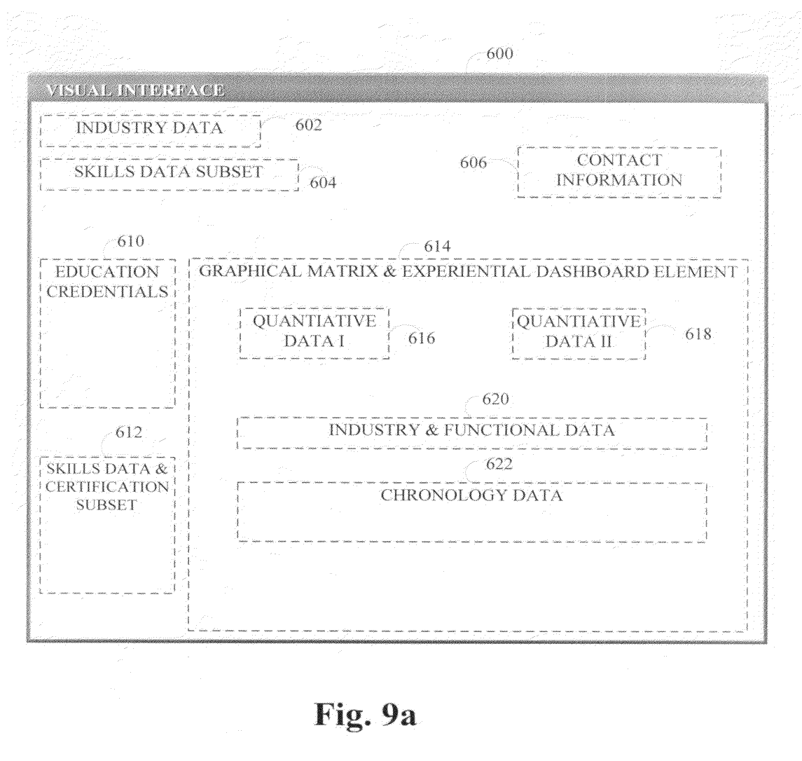

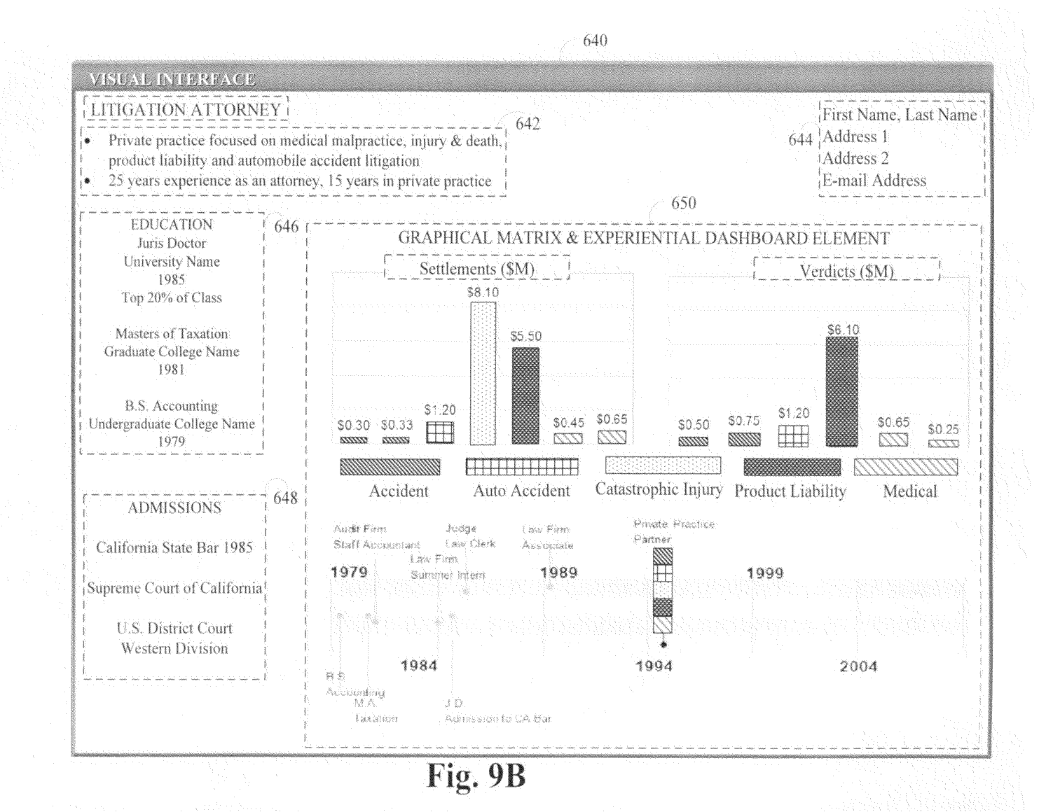

FIG. 6a illustrates a sample graphical interface as generated by the system and method for visualizing curriculum vitae data. As illustrated, the sample graphical interface 300 includes the same dashboard elements and data sets of FIG. 5a. In addition, the sample graphical interface 300 further includes an education & credentials element 302 and a quantitative data element 304.

FIG. 6b illustrates a sample graphical interface as generated by the system and method for visualizing curriculum vitae data. Similar to the interface of FIG. 5b, the sample graphical interface includes 310 a graphical matrix dashboard element 312 and a graphical experiential dashboard element 314. The graphical matrix dashboard element 312 represents the chronology data in as timeline graphic, including titles associated with employment, and the industry data is represented as an industry bar graph over time.

As illustrated in FIG. 6b, the skills subset data may be represented as a set of ratings associated with a particular skill. The education & credentials element 316 includes a university name, geographic city, geographic state, a degree, a major field of study, a minor field of study and a set of certifications with their associated status. Also illustrated in FIG. 6b is the shading of the graphic element representing the quantitative data element 318. The shading of the quantitative data element 318 indicates the relationship or association between data represented in the graphical matrix dashboard element and the graphical experimental dashboard element.

FIGS. 1 through 6 are conceptual illustrations allowing for an explanation of the present invention. The visual representations may be aided by any number of analysis or rendering programs or software, such as Microsoft Excel, PowerPoint, Word, Access or VISIO, which are known to those skilled in the art. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). Since other modifications or changes will be apparent to those skilled in the art, there have been described above the principles of this invention in connection with specific apparatus, it is to be clearly understood that this description is made only by way of example and not as a limitation to the scope of the invention. In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the claimed system and method to a single embodiment, as other embodiments are possible by way of interchange of some or all of the described or illustrated elements. Moreover, where certain elements of the system and method can be partially or fully implemented using known components, only those portions of such known components that are necessary for an understanding of the system and method are described, and detailed descriptions of other portions of such known components are omitted so as not to obscure the system and method. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration. The foregoing description of the specific embodiments so fully reveals the general nature of the claimed system and method that others can, by applying knowledge within the skill of the relevant art(s) (including the contents of the documents cited and incorporated by reference herein), readily modify and/or adapt for various applications such specific embodiments, without undue experimentation, without departing from the general concept of the claimed system and method. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the claimed system and method have been described above, it should be understood that they have been presented by way of example, and not limitation. It would be apparent to one skilled in the relevant art(s) that various changes in form and detail could be made therein without departing from the spirit and scope of the claimed systems and methods. Thus, the claimed system and method should not be limited by any of the above-described exemplary embodiments, but should be defined only in accordance with the following claims and their equivalents.

Since other modifications or changes will be apparent to those skilled in the art, there have been described above the principles of the claimed system and method in connection with specific apparatus, or specific implementations of process embodiments it is to be clearly understood that this description is made only by way of example and not as a limitation.

What is claimed is:

1. A method for visualizing individuated curriculum vitae data, comprising steps of:
receiving a foundation data set including at least one of matrix data and experiential data;
structuring the foundation data set into at least one schema framework including a dashboard element;
mapping the dashboard element in a given schema framework to form relationship metadata within the foundation data set; and
generating an adaptive graphic visualization representing the foundation data set including a customizable interface layout.

2. The method for visualizing individuated curriculum vitae data of claim 1 wherein the foundation data set includes matrix data comprising a chronology field and an industry field.

3. The method for visualizing individuated curriculum vitae data of claim 1 wherein the foundation data set includes experiential data comprising a functional subset and a skills subset, the functional subset including an umbrella field and the skills subset includes a set of skill fields associated with a corresponding set of skill weights.

4. The method for visualizing individuated curriculum vitae data of claim 1 further comprising steps of:
associating matrix data with a graphical matrix dashboard element;
associating experiential data with a graphical experiential dashboard element;
representing relationship metadata within the foundation data set through a common attribute shared between the graphical matrix dashboard element and the graphical experiential dashboard element.

5. The method for visualizing individuated curriculum vitae data of claim 4 wherein associating matrix data with the graphical matrix dashboard element includes a user-defined preference, the user-defined preference including a selection of shape and color.

6. The method for visualizing individuated curriculum vitae data of claim 5 wherein representing relationship metadata within the foundation data set through a common attribute further comprises a step of:
influencing a visual characteristic of the graphical experiential dashboard element relative to data represented by the graphical matrix dashboard element.

7. The method for visualizing curriculum vitae data of claim 1 wherein the adaptive graphic visualization includes an interactive component, the interactive component including an operator configured to return a refined data set from the foundation data set upon request.

8. The method for visualizing curriculum vitae data of claim 7 wherein the adaptive graphic visualization includes a plurality of interactive components, each one of the interactive components being associated with a given dashboard element.

9. Computer readable media comprising program code that when executed by a programmable processor causes execution of a method for visualizing curriculum vitae data, the computer readable media comprising:
program code for receiving a foundation data set including at least one of matrix data and experiential data;
program code for structuring the foundation data set into at least one schema framework including a dashboard element;
program code for mapping the dashboard element in a given schema framework to form relationship metadata within the foundation data set; and
program code for generating an adaptive graphic visualization representing the foundation data set including a customizable interface layout.

10. The computer readable media of claim 9 wherein the program code for receiving a foundation data set including matrix data and experiential data further comprises:
program code for receiving a chronology field and an industry field as matrix data.

11. The computer readable media of claim 9 the program code for receiving a foundation data set including matrix data and experiential data further comprises:
program code for receiving a functional subset and a skills subset as experiential data, the functional subset including an umbrella field and the skills subset including a set of skill fields associated with a corresponding set of skill weights.

12. The computer readable media of claim 9 the program code for receiving a foundation data set including matrix data and experiential data further comprises:
program code for receiving a quantitative data set.

13. The computer readable media of claim 9 further comprising:
program code for associating matrix data with a graphical matrix dashboard element;
program code for associating experiential data with a graphical experiential dashboard element;
program code for representing relationship metadata within the foundation data set through a common attribute shared between the graphical matrix dashboard element and the graphical experiential dashboard element.

14. The computer readable media of claim 13 wherein the program code for associating matrix data with the graphical matrix dashboard element further comprises:
program code for receiving a user-defined preference, the user-defined preference including a selection of shape and color.

15. The computer readable media of claim 13 wherein the program code for representing relationship metadata within the foundation data set through a common attribute further comprises:
program code for influencing a visual characteristic of the graphical experiential dashboard element relative to data represented by the graphical matrix dashboard element.

16. The computer readable media of claim 9 wherein the program code for program code for generating the adaptive graphic visualization further comprises:
program code for presenting an interactive component, the interactive component including an operator configured to return a refined data set from the foundation data set upon request.

17. The computer readable media of claim 16 wherein the program code for presenting an interactive component further comprises:
program code for presenting a plurality of interactive components, each one of the interactive components being associated with a given dashboard element.
